(19) United States
(12) Patent Application Publication
(10) Pub. No.: US 2008/0049210 A1
(43) Pub. Date: Feb. 28, 2008

(54) Range-finding sensor, and electronic device equipped with range-finding sensor

(75) Inventor: Takashi Takaoka, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/889,604

(22) Filed: Aug. 15, 2007

(30) Foreign Application Priority Data
Aug. 28, 2006 (JP) 2006-230724

(51) Int. Cl. G01B 11/00

(52) U.S. Cl. 356/3

(57) ABSTRACT

In one embodiment of the range-finding sensor of the invention, a light-emitting element that projects light to a range-finding subject, and a light-receiving element that receives reflected light reflected by the range-finding subject, are disposed on a reference face, and the light-emitting element and the light-receiving element are each individually sealed with resin by a translucent resin sealing portion. Further, the outer circumference of the translucent resin sealing portion is covered by an opaque resin sealing portion, and the opaque resin sealing portion is provided with a light-emitting portion slit that constricts the luminous flux of light projected to the range-finding subject, and a light-receiving portion slit that constricts the luminous flux of reflected light reflected by the range-finding subject.

This application claims priority under 35 U.S.C. § 119(a) on Japanese Patent Application No. 2006-230724 filed in Japan on Aug. 28, 2006, the entire contents of which are hereby incorporated by reference.

### BACKGROUND OF THE INVENTION

1. Field of the Invention

The present invention relates to a range-finding sensor that employs a triangular range-finding system and detects the distance to a range-finding subject, the range-finding sensor being provided with a light-emitting element that projects light to the range-finding subject and a light-receiving element that receives light reflected by the range-finding subject.

2. Description of the Related Art

In the conventional technology, range-finding sensors are known that employ a triangular range-finding system and detect the distance to a range-finding subject by projecting light to the range-finding subject and receiving light reflected by the range-finding subject.

FIG. 4 illustrates a distance-measuring principle of a range-finding sensor employing a triangular range-finding system according to Conventional Example 1.

This range-finding sensor is configured with a light-emitting element 112 that projects light to range-finding subjects 131 and 132, a projection lens 118 that constricts the luminous flux of light irradiated from the light-emitting element 112, a light-receiving element 113 that receives light reflected by the range-finding subjects 131 and 132, and a condensing lens 119 that constricts the luminous flux of light reflected by the range-finding subjects 131 and 132. The light-emitting element 112 is configured with an infrared light-emitting diode (LED), and the light-receiving element 113 is configured with a semiconductor position sensitive detector (PSD).

The light projected from the light-emitting element 112 (projected in the direction of arrows L1 and L3 in FIG. 4) is constricted to a fine beam of light by the projection lens 118, and projected to the range-finding subjects 131 and 132. The reflected light reflected by the range-finding subjects 131 and 132 (reflected in the direction of arrows L2 and L4 in FIG. 4) is condensed on a light-receiving face 114 of the light-receiving element 113 by the condensing lens 119.

At this time, condensing positions (spot positions) P1 and P2 of the reflected light condensed by the condensing lens 119 change according to the distance from the range-finding sensor to the range-finding subjects 131 and 132. For example, the reflected light (reflected in the direction of arrow L2) reflected by the range-finding subject 131 that is closer to the range-finding sensor is condensed at the position P1, which is further from the light-emitting element 112 than the reflected light (reflected in the direction of arrow L4) reflected by the range-finding subject 132 that is further from the range-finding sensor.

Thus, the light-receiving element 113 is disposed such that the light-receiving face 114 overlaps with the range of fluctuation of the change in the condensing positions (spot positions) P1 and P2 of the reflected light, and by processing the photocurrent output that is output from the light-receiving element 113, it is possible to detect the distance of the range-finding subjects 131 and 132.

FIG. 5 is a cross-sectional diagram that shows the structure of the range-finding sensor employing a triangular range-finding system according to Conventional Example 1.

The light-emitting element 112, the light-receiving element 113, and a signal processing element 120 that processes signals from the light-receiving element 113 are mounted on lead frames 111a and 111b.

The elements 112, 113, and 120 are each individually resin-sealed by a translucent resin sealing portion (a light-emitting side translucent resin sealing portion 115, and a light-receiving side translucent resin sealing portion 116). Moreover, the outer circumference of the translucent resin sealing portions 115 and 116 is covered by an opaque resin sealing portion 117.

Herein, holes (light-emitting side: 121, light-receiving side: 122) are provided in the opaque resin sealing portion 117, such that light projected from the light-emitting element 112 and reflected light reflected by the range-finding subjects can be allowed to pass through.

Further, a lens case 123 made of translucent resin, with which the projection lens 118 and the condensing lens 119 are formed as a single body, is provided so as to surround the outer circumference of the opaque resin sealing portion 117.

In this sort of range-finding sensor 110, it is necessary to set the distance between the condensing lens 119 and the light-receiving element 113 to a predetermined distance, and it is also necessary to set the size (diameter and thickness) of the projection lens 118 and the condensing lens 119 to a predetermined size, so the dimensions of the range-finding sensor 110 as a whole are large.

FIG. 6 illustrates a range-finding sensor employing a triangular range-finding system according to Conventional Example 2, and shows a cross-sectional view of a range-finding sensor 110. FIG. 7 is a partial enlarged view in which portion A in FIG. 6 has been enlarged, and illustrates a light path of reflected light that has been reflected from a range-finding subject.

A device 125, provided with a light-emitting element (LED) 112 and a light-receiving element (semiconductor position sensitive detector) 113 that are mounted on a substrate 111, is built into a case 123 made of opaque resin.

A slit (a light-emitting portion slit 118 and a light-receiving portion slit 119) is provided on the light-emitting portion side and the light-receiving portion side in the case 123. The light-emitting portion slit 118 acts to constrict the luminous flux of light projected from the light-emitting element 112 (projected in the direction of arrow L1 in FIG. 6), and the light-receiving portion slit 119 acts to constrict the luminous flux of reflected light reflected by a range-finding subject 130 (reflected in the direction of arrow L2 in FIG. 6).

In the range-finding sensor according to Conventional Example 2, the light-emitting portion slit 118 and the light-receiving portion slit 119 are provided instead of a projection lens and a condensing lens, and thus reduced size of the range-finding sensor is realized

A range-finding sensor as described above, in which a light-emitting portion slit and a light-receiving portion slit are provided instead of a projection lens and a condensing lens, is proposed in JP H07-19859A (hereinafter, Patent Document 1), JP H10-26524A (hereinafter, Patent Document 2), and JP 2004-11716A (hereinafter, Patent Document 3), and therein, reduced size of the range-finding sensor is realized by substituting a light-emitting portion slit or a light-receiving portion slit for at least one of the projection lens and the condensing lens.

However, in the range-finding sensor according to Conventional Example 2 shown in FIG. 6 and the range-finding sensor described in Patent Document 1, a configuration is adopted in which the case 123 and the device 125 are combined, so the position of the slits (the light-emitting portion slit 118 and the light-receiving portion slit 119) formed in the case 123 and the position of the elements (the light-emitting element 112 and the light-receiving element 113) are often offset from each other, with the result that there is not a large reduction in size.

Also, when the slits (the light-emitting portion slit 118 and the light-receiving portion slit 119) have been provided in the case 123, there is a risk that dust will enter from the slits 118 and 119 into spaces 126 and 127 between the case 123 and the device 125.

Thus, in the range-finding sensor according to Conventional Example 2 or the range-finding sensor described in Patent Document 3, the introduction of the aforementioned dust is prevented by applying a translucent filter 128 to the light-exiting side of the light-emitting portion slit 118 and the light-entering side of the light-receiving portion slit 119. However, because a process of applying the translucent filter 128 is necessary, the manufacturing process of those range-finding sensors is complicated.

Also, as shown in FIG. 7, in the range-finding sensor 110 provided with the light-receiving portion slit 119 as shown in FIG. 6 and described in Patent Documents 1, 2, and 3, the reflected light (reflected in the direction of arrow L3 in FIG. 7) reflected by one slit face 119a of the case 123 used to configure the light-receiving portion slit 119 is further reflected by another slit face 119b of the case 123 (reflected in the direction of arrow L4 in FIG. 7), and then arrives at the light-receiving face 114 of the light-receiving element 113. Thus accurate range-finding cannot be performed.

### SUMMARY OF THE INVENTION

The present invention was made in view of such circumstances, and it is an object thereof to provide a small range-finding sensor that can be easily manufactured, and an electronic device equipped with that sensor.

The range-finding sensor according to the present invention is a range-finding sensor that employs a triangular range-finding system that detects the distance to a range-finding subject, and includes a light-emitting element that projects light to the range-finding subject and a light-receiving element that receives reflected light reflected by the range-finding subject; in which the range-finding sensor further comprises a translucent resin sealing portion that individually seals with resin each of the light-emitting element and the light-receiving element that are disposed on a reference face, and an opaque resin sealing portion that covers the outer circumference of the translucent resin sealing portions, and the opaque resin sealing portion is provided with a light-emitting portion slit that constricts the luminous flux of light projected to the range-finding subject, and a light-receiving portion slit that constricts the luminous flux of reflected light reflected by the range-finding subject.

With this configuration, the luminous flux of the light projected from the light-emitting element is projected to the range-finding subject in a state constricted by the light-emitting portion slit, and the luminous flux of the reflected light reflected by the range-finding subject is condensed on the light-emitting face of the light-receiving element in a state constricted by the light-receiving portion slit. In other words, it is not necessary to provide a projection lens and a condensing lens in the range-finding sensor, and thus it is possible to achieve a reduction in the size of the range-finding sensor.

Also, the light-emitting portions slit and the light-receiving portion slit are provided in the opaque resin sealing portion, and a slit (hole) is not provided in the translucent resin sealing portion that seals the light-emitting element and the light-receiving element with resin, so dust or the like is not introduced inside the translucent resin sealing portion, and thus there is no affixing of dust or the like to the light-emitting element or the light-receiving element.

Accordingly, it is not necessary to prevent the introduction of dust by applying a translucent filter to the light-exiting side of the light-emitting portion slit and the light-entering side of the light-receiving portion slit, so manufacture of the range-finding sensor is easy because it is possible to omit the process of applying a filter.

Also, in the range-finding sensor according to the invention, it is possible to adopt a configuration in which the light-receiving portion slit has a rectangular shape with a long side that is longer than the width of the light-receiving face of the light-receiving element.

With this configuration, a long and thin light spot that spreads in the widthwise direction of the light-receiving face is incident on the light-receiving face of the light-receiving element. Thus, in comparison to a case in which for example a round light spot is incident on the light-receiving face, it is possible to receive a greater amount of light, and thus the range-finding sensor can have high precision.

Also, in the range-finding sensor according to the invention, it is possible to adopt a configuration in which the light-emitting portion slit has a rectangular shape, and is disposed parallel to the light-receiving portion slit.

With this configuration, a long, thin light beam is projected toward the range-finding subject, so it is possible to effectively irradiate the reflected light reflected by the range-finding subject to the light-receiving face of the light-receiving element.

Also, in the range-finding sensor according to the invention, it is possible to adopt a configuration in which in the opaque resin sealing portion, relative to the light-receiving portion slit, a top face of a side nearer to the light-emitting element is formed flush with a bottom face of a side farther from the light-emitting element.

With this configuration, it is possible to prevent reflected light reflected by the opaque resin sealing portion from passing through the light-receiving portion slit and being irradiated on the light-receiving face of the light-receiving element. In other words, the influence of light reflected by the opaque resin sealing portion can be reduced, so the range-finding sensor can have high precision.

Also, in the range-finding sensor according to the invention, it is possible to adopt a configuration in which the translucent resin sealing portion has a top face formed flush with the top face of the opaque resin sealing portion.

With this configuration, there is not a space into which dust will be introduced between the translucent resin sealing portion and the opaque resin sealing portion, so it is not necessary to be concerned about a decrease in detection sensitivity due to introduction of dust. In other words, it is not necessary to apply a filter in order to prevent the introduction of dust.

Also, in the range-finding sensor according to the invention, it is possible to adopt a configuration in which the light-receiving element and a signal processing element that processes signals from the light-receiving element are formed in a single chip.

With this configuration, it is possible to achieve a reduction in the size of the range-finding sensor, and to more easily manufacture the range-finding sensor.

Also, in the range-finding sensor according to the invention, it is possible to adopt a configuration in which the light-receiving element is configured with a semiconductor position sensitive detector.

Also, in the range-finding sensor according to the invention, it is possible to adopt a configuration in which the light-receiving element is configured with a plurality of photodiodes.

Also, the electronic device according to the invention is equipped with the above-described range-finding sensor according to the invention.

With this configuration, it is possible realize a reduction in the size of an electronic apparatus equipped with a range-finding sensor.

### BRIEF DESCRIPTION OF THE DRAWINGS

FIG. 1 illustrates the structure of a range-finding sensor according to Embodiment 1 of the invention and a distance measuring principle thereof.

FIG. 2 is a plan view in which a light-receiving element portion in FIG. 1 is viewed from the side of a light-receiving portion slit.

FIG. 3 is a partial enlarged view of portion A in FIG. 1.

FIG. 4 illustrates a distance measuring principle of a range-finding sensor that employs a triangular range-finding system according to Conventional Example 1.

FIG. 5 is a cross-sectional view that shows the structure of the range-finding sensor according to Conventional Example 1.

FIG. 6 illustrates a range-finding sensor according to Conventional Example 2.

FIG. 7 is a partial enlarged view of portion A in FIG. 6.

### DESCRIPTION OF THE PREFERRED EMBODIMENTS

Hereinafter, embodiments of the present invention will be described in detail with reference to the accompanying drawings.

### First Embodiment

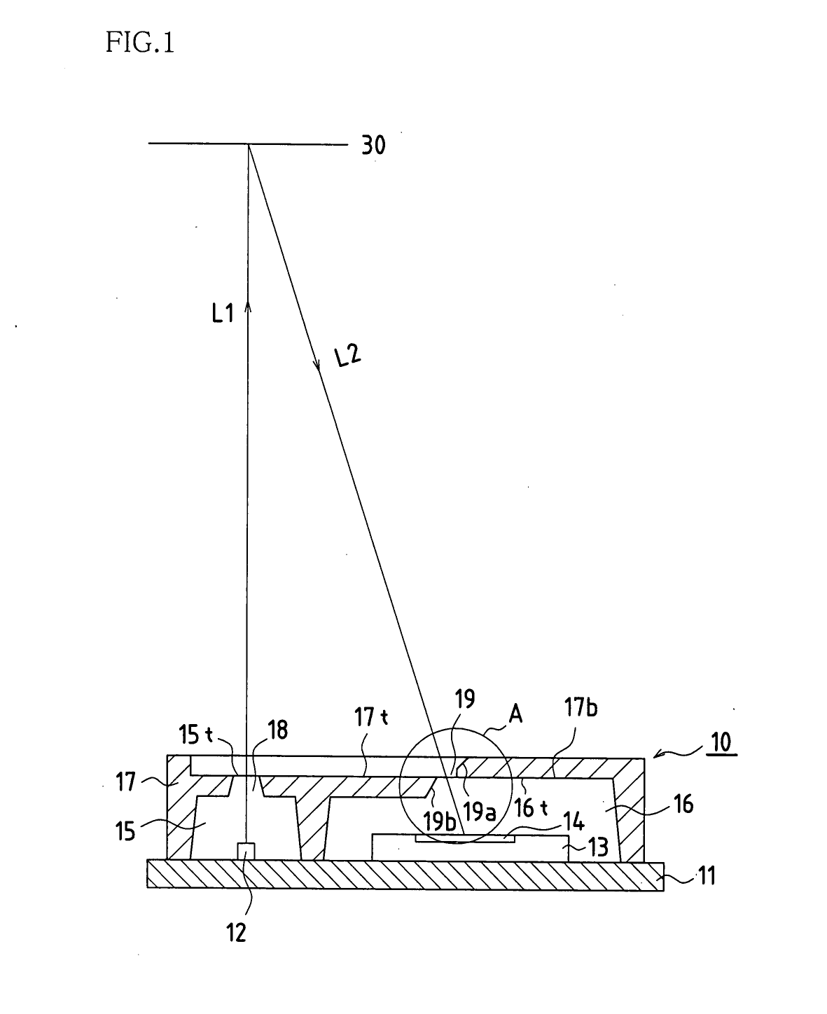

FIG. 1 illustrates the structure of a range-finding sensor according to Embodiment 1 of the invention and a distance measuring principle thereof. A cross-sectional view of a range-finding sensor 10 is shown in FIG. 1. Hatching is omitted from the cross-section of a light-emitting element 12, a light-receiving element 13, and translucent resin sealing portions 15 and 16.

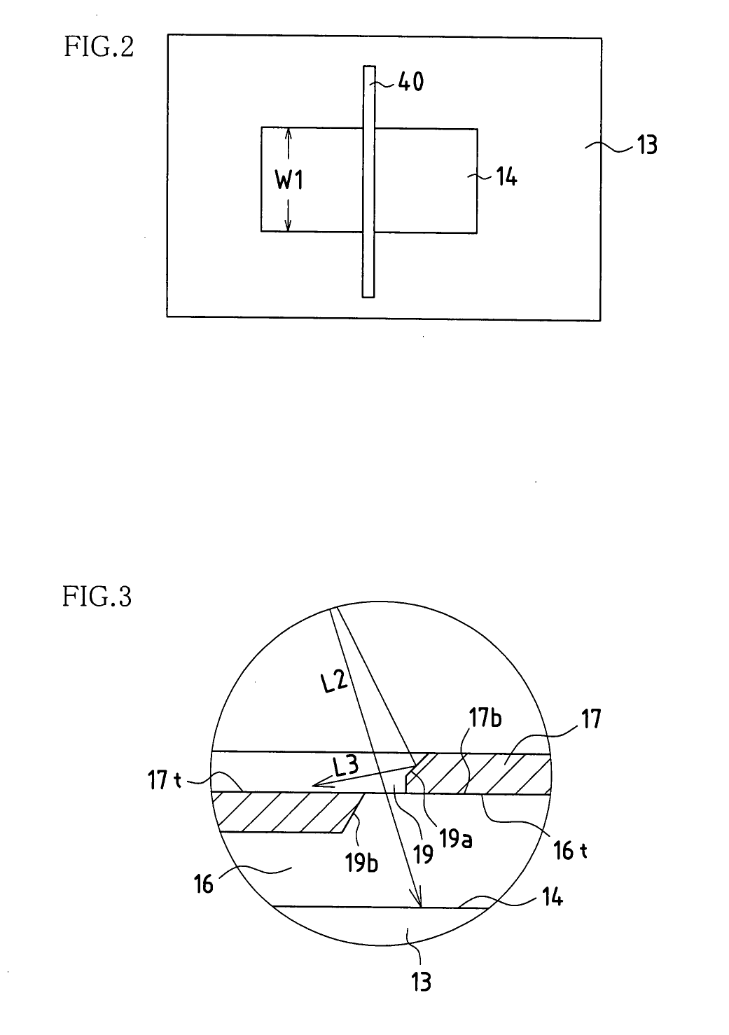

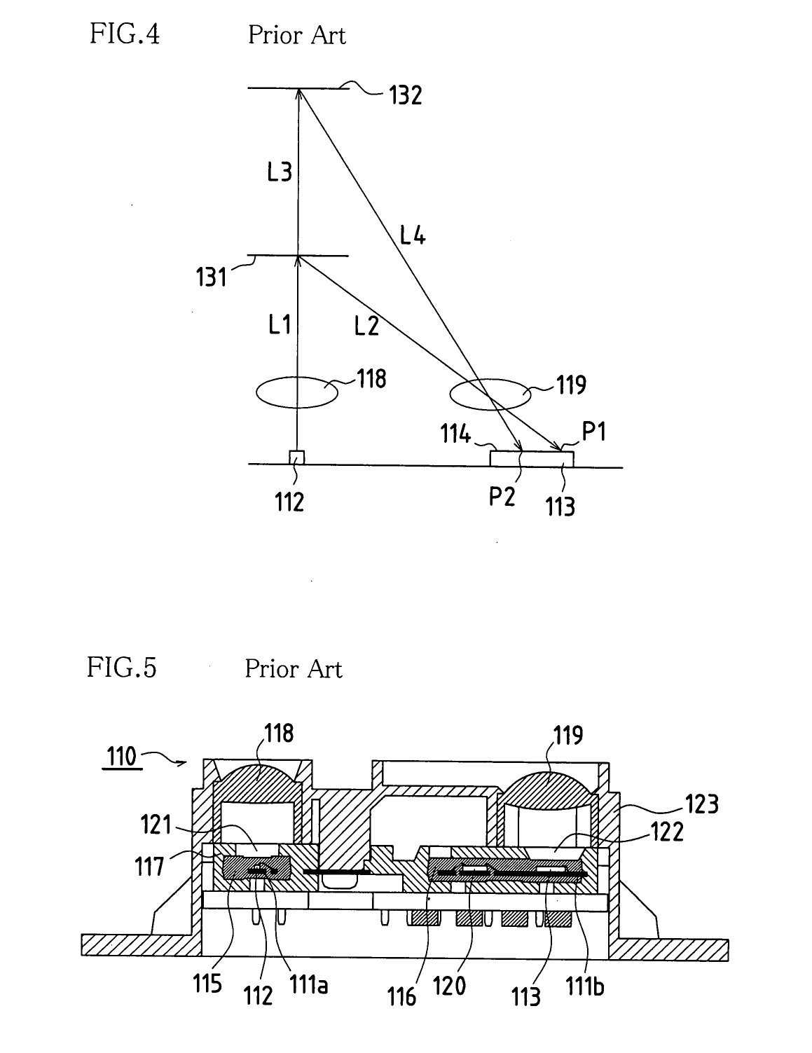

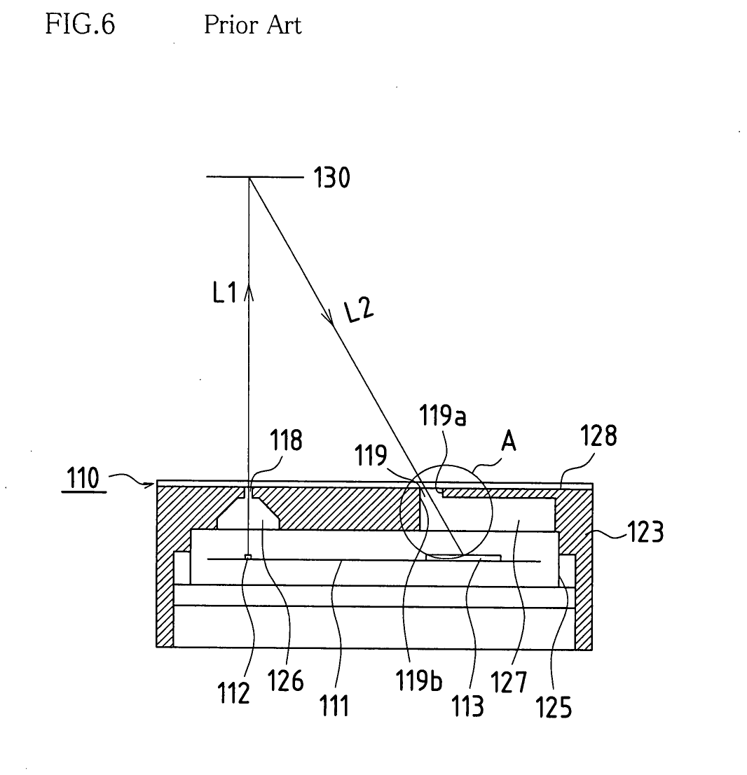

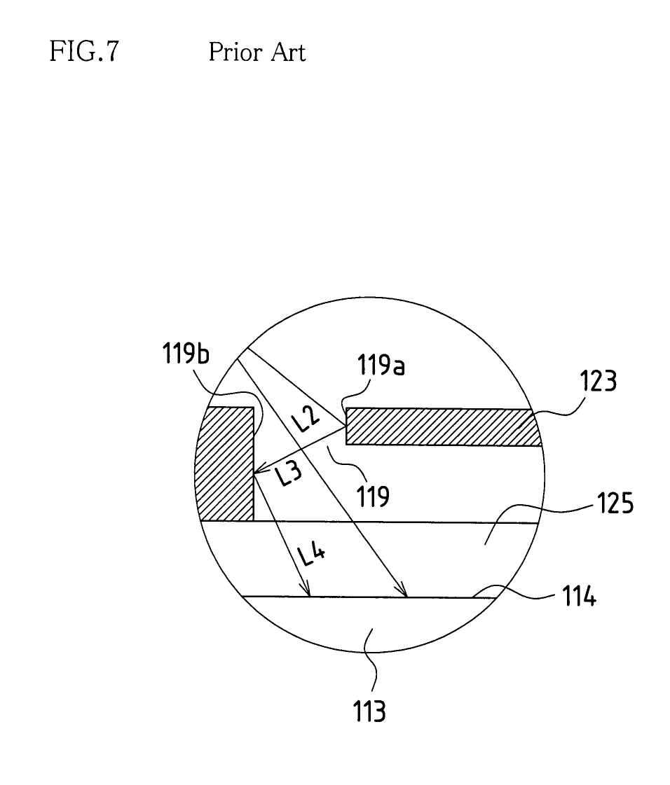

FIG. 2 is a plan view in which the light-receiving element portion in FIG. 1 is viewed from the side of a light-receiving portion slit, and illustrates a state in which light has been condensed on a light-receiving face of the light-receiving element. FIG. 3 is a partial enlarged view of portion A in FIG. 1, and illustrates a light path of reflected light reflected by a range-finding subject.

The range-finding sensor 10 according to the present embodiment is configured with a substrate 11, the light-emitting element 12 and the light-receiving element 13 disposed on the upper face (reference face) of the substrate 11, that translucent resin sealing portions 15 and 16 that respectively seal the light emitting element 12 and the light-receiving element 13 with resin, and an opaque resin sealing portion 17.

The substrate 11 has a face (reference face) used as a reference when range-finding, and is configured with, for example, a lead frame, a print substrate, or the like.

The light-emitting element 12 is configured with an infrared light-emitting diode (LED), and is die-bonded and wire-bonded (not shown) to the upper face (reference face) of the substrate 11.

The light-receiving element 13 is configured with a semiconductor position sensitive detector (PSD) or a plurality of photodiodes.

Also, the light-receiving element 13 is disposed on the upper face of the substrate 11 such that a light-receiving face 14 overlaps with the range of fluctuation of the condensing position of the reflected light reflected by a range-finding subject 30.

The light-receiving element 13 is preferably formed in a single chip along with a signal processing element (not shown) that processes signals from the light-receiving element 13. More specifically, by forming the light-receiving element 13 and a signal processing element in a single chip, it is possible to more easily design the arrangement of the light-emitting element 12 and the light-receiving element 13 on the upper face of the substrate 11, and possible to realize a reduced size for the range-finding sensor 10.

Same as the light-emitting element 12, the light-receiving element 13 is die-bonded and wire-bonded (not shown) to the upper face (reference face) of the substrate 11.

Also, the light-emitting element 12 and the light-receiving element 13 are each individually resin-sealed by a translucent resin sealing portion (the light-emitting side translucent resin sealing portion 15 and the light-receiving side translucent resin sealing portion 16), and moreover, the outer circumference of the translucent resin sealing portions 15 and 16 are covered by the opaque resin sealing portion 17.

Also, on the side of the opaque resin sealing portion 17 where the light-receiving element 13 is disposed, a light-receiving portion slit 19 for constricting the luminous flux of reflected light reflected by the range-finding subject 30 (reflected in the direction of arrow L2 in FIG. 1) is provided.

The light-receiving portion slit 19 is formed in a rectangular shape whose long side is longer than a width W1 of the light-receiving face of the light-receiving element 13. More specifically, the light-receiving portion slit 19 is formed such that a thin and long light spot 40 is incident in the direction of the width W1 of the light-receiving face 14 of the light-receiving element 13 (see FIG. 2). Note that the width W1 of the light-receiving face 14 of the light-receiving element 13 referred to here refers to the width W1 of the light-receiving face 14 in the direction perpendicular to the light path of the light condensed at the light-receiving element 13.

By, in this manner, forming the light-receiving portion slit 19 in a rectangular shape, and condensing the reflected light reflected by the range-finding subject 30 on the light-receiving face 14 of the light-receiving element 13 as a long and thin light spot 40 that spreads in the direction of the width W1, a greater amount of light is received and thus precision is increased.

Also, on the side of the opaque resin sealing portion 17 where the light-emitting element 12 is disposed, a light-emitting portion slit 18 is provided that constricts the luminous flux of light projected from the light-emitting element 12 (projected in the direction of arrow L1 in FIG. 1).

The light-emitting portion slit 18 has a rectangular shape, and is disposed parallel to the light-receiving portion slit 19. More specifically, the light-emitting portion slit 18 is formed so as to project a long, thin light beam toward the range-finding subject 30. Thus, it is possible to effectively irradiate the reflected light reflected by the range-finding subject 30 to the light-receiving face 14 of the light-receiving element 13.

Also, the opaque resin sealing portion 17 is formed such that, relative to the light-receiving portion slit 19, a top face 17t on the side nearer to the light-emitting element 12 is flush with a bottom face 17b on the side farther from the light-emitting element 12.

More specifically, as shown in FIG. 3, the opaque resin sealing portion 17 is formed such that reflected light (reflected in the direction of arrow L3 in FIG. 3) reflected by a slit face 19a on one side (the side farther from the light-emitting element 12) of the opaque resin sealing portion 17, the slit face 19a being a constituent of the light-receiving portion slit 19, escapes to the outside of the light-receiving portion slit 19 (to the outside of the translucent resin sealing portion 16).

In this manner, in the range-finding sensor 10 according to the present embodiment, the opaque resin sealing portion 17 is formed such that range-finding can be performed without being influenced by light reflected by the opaque resin sealing portion 17, so accurate and precise range-finding is possible.

Also, the translucent resin sealing portions 15 and 16 have top faces 15t and 16t that are formed flush with the top face 17t of the opaque resin sealing portion 17 on the side nearer to the light-emitting element 12 relative to the light-receiving portion slit 19. In other words, the translucent resin sealing portions 15 and 16 are formed such that a space into which dust enters is not formed between the translucent resin sealing portions 15 and 16 and the opaque resin sealing portion 17.

As described above, in the range-finding sensor 10 according to the present embodiment, the light-emitting portion slit 18 and the light-receiving portion slit 19 are provided in the opaque resin sealing portion 17, and not provided in the translucent resin sealing portions 15 and 16 that seal the light-emitting element 12 and the light-receiving element 13 with resin. More specifically, because dust or the like does not enter inside the translucent resin sealing portions 15 and 16, there is no affixing of dust or the like to the light-emitting element 12 or the light-receiving element 13.

Thus, it is not necessary to prevent the introduction of dust by applying a translucent filter to the light-exiting side of the light-emitting portion slit 18 and the light-entering side of the light-receiving portion slit 19, so manufacturing is easy because it is possible to omit the process of applying a filter.

The distance-measuring principle of the range-finding sensor 10 according to the present embodiment is roughly the same as the distance-measuring principle of the range-finding sensor of the conventional example described above.

That is, light projected from the light-emitting element 12 (projected in the direction of arrow L1 in FIG. 1) is converted to a long, thin light beam by the light-emitting portion slit 18, and projected to the range-finding subject 30. The reflected light reflected by the range-finding subject 30 (reflected in the direction of arrow L2 in FIG. 1) is condensed by the light-receiving portion slit 19 on the light-receiving face 14 of the light-receiving element 13 as the light spot 40 with a long, thin shape as shown in FIG. 2.

Moreover, by processing the photoelectric current output that is output from the light-receiving element 13 according to the position of the light spot 40 condensed on the light-receiving face 14 with a signal processing element, a mechanism for detecting the distance of the range-finding subject 30 is formed.

### Embodiment 2

An electronic device (not shown) according to the present embodiment is equipped with a range-finding sensor according to Embodiment 1. Because this electronic device is equipped with a small and highly precise range-finding sensor, the electronic device is small and has high precision.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A range-finding sensor employing a triangular range-finding system that detects the distance to a range-finding subject, the range-finding sensor comprising a light-emitting element that projects light to the range-finding subject and a light-receiving element that receives reflected light reflected by the range-finding subject, wherein
the range-finding sensor further comprises a translucent resin sealing portion that individually seals with resin each of the light-emitting element and the light-receiving element that are disposed on a reference face, and an opaque resin sealing portion that covers the outer circumference of the translucent resin sealing portions, and
the opaque resin sealing portion is provided with a light-emitting portion slit that constricts the luminous flux of light projected to the range-finding subject, and a light-receiving portion slit that constricts the luminous flux of reflected light reflected by the range-finding subject.

2. The range-finding sensor according to claim 1, wherein the light-receiving portion slit has a rectangular shape with a long side that is longer than the width of the light-receiving face of the light-receiving element.

3. The range-finding sensor according to claim 1, wherein the light-emitting portion slit has a rectangular shape, and is disposed parallel to the light-receiving portion slit.

4. The range-finding sensor according to claim 2, wherein the light-emitting portion slit has a rectangular shape, and is disposed parallel to the light-receiving portion slit.

5. The range-finding sensor according to any one of claims 1 to 4, wherein in the opaque resin sealing portion, relative to the light-receiving portion slit, a top face of a side nearer to the light-emitting element is formed flush with a bottom face of a side farther from the light-emitting element.

6. The range-finding sensor according to any one of claims 1 to 4, wherein the translucent resin sealing portion has a top face formed flush with the top face of the opaque resin sealing portion.

7. The range-finding sensor according to claim 5, wherein the translucent resin sealing portion has a top face formed flush with the top face of the opaque resin sealing portion.

8. The range-finding sensor according to any one of claims 1 to 4, wherein the light-receiving element and a signal processing element that processes signals from the light-receiving element are formed in a single chip.

9. The range-finding sensor according to any one of claims 1 to 4, wherein the light-receiving element comprises a semiconductor position sensitive detector.

10. The range-finding sensor according to any one of claims 1 to 4, wherein the light-receiving element comprises a plurality of photodiodes.

11. An electronic device equipped with the range-finding sensor according to claim 1.
